(19) United States
(12) Patent Application Publication
(10) Pub. No.: US 2023/0162247 A1
(43) Pub. Date: May 25, 2023

(54) SYSTEM FOR DETERMINING BILLING FOR TRANSPORTATION USAGE

(71) Applicant: MOOVIT APP GLOBAL LTD., Ness Ziona (IL)

(72) Inventors: Binyamin Galon, Tzur Hadassah (IL); Roy Bick, Kfar Saba (IL); Simon Jonathan Karnis, Rehovot (IL); Gil Emanuel Fuchs, Ness Ziona (IL); Nir Bezalel, Rehovot (IL); Anan Kenig, Holon (IL)

(21) Appl. No.: 17/919,543

(22) PCT Filed: Mar. 7, 2021
(86) PCT No.: PCT/IL2021/050247

§ 371 Date: Oct. 18, 2022

Related U.S. Application Data
(60) Provisional application No. 63/012,169, filed on Apr. 19, 2020.

(51) Int. Cl. G06Q 30/0283; G06Q 50/30

(52) U.S. Cl. CPC G06Q 30/0284; G06Q 50/30

(57) ABSTRACT

There is provided herein a system for tracking a user's use of available modes of transportation during a trip, the system comprising: a GNSS receiver configured; an IMU; and one or more processors that operates in accordance with a set of instructions stored in a memory to: generate a geotemporal record of a travel route of the trip based on location data provided by the GNSS and inertial data provided by the IMU; and determine, based on the geotemporal record, at least one vehicular trip segment. There is also provided herein a system for tracking a user's use of available modes of transportation during a trip, the system comprising: a remote hub comprising a transportation data repository; and one or more processors to determine, based on a user record of the trip and the transportation data repository, at least one vehicular trip segment.

### RELATED APPLICATIONS

This application claims benefit under 35 U.S.C. 119(e) of U.S. Provisional Application 63/012,169 filed Apr. 19,2020 the disclosure of which is incorporated herein by reference.

### FIELD

Embodiments of the disclosure relate to providing information relevant to identifying and charging for use of modes of transportation.

### BACKGROUND

Movement of people in today's modern environment is supported by an ever-increasing myriad of different modes of transportation that cooperate, compete, and intersect with each other to provide a modern traveler with means for moving between desired locations. Among the modes of transportation, in addition to the most basic and once most natural means of movement from place to place—walking—that a modern citizen has available for his or her use are recently developed and deployed micromobility modes of transportation as well as the familiar transportation on demand (TOD) and public transport system (PTS) modes of transportation. Micromobility modes of transportation (MIMOTs) conventionally refer to transportation using vehicles, hereinafter also referred to as “little vehicles” (LIVs), that may weigh less than about 500 kg and operated by a passenger. LIVs may include, by way of example, electric skateboards, hoverboards scooters, bicycles golf carts, and possibly little, personal dockless cars. Transportation on demand (“TOD”) includes movement by vehicles for hire such as taxis, limousines, buses, rickshaws and Jeepneys and may include various types of personal dockless cars. Public transportation modes refer to modes of transportation that employ public transport vehicles, vehicle's that are typically available to the general public, travel established routes according to published schedules and charge posted fees. Public transport vehicles include by way of example, buses, trains, and water going vehicles such as ferries. TOD vehicles and public transport vehicles may be operated by a human driver or operated autonomously without a human driver.

Whether MIMOT, TOD, or PTS, mode of transportation, to be sustainable, the mode has to be supported by a suitable level of public and/or private funding. As modern users may engage and use many different modes of transportation, even when moving relatively short distances between locations, keeping track of the use of the various modes of transportation and allocating funding, whether directly or indirectly via public taxation and/or personal payment, are complex, high-overhead tasks.

### SUMMARY

An aspect of an embodiment of the disclosure relates to providing a system for tracking a user's use of available modes of transportation and optionally allocating payment, hereinafter also referred to as billing, for the use. The system, hereinafter also referred to as a universal movement monitoring (UMOM) system, comprises: at least one location and/or motion (LOCAMO) tracker that provides data, optionally “LOCAMO data”, that may be used to determine location and/or motion of the user as a function of time; a module, also referred to as a LOCAMO module, for processing LOCAMO data; and optionally a billing module. The LOCAMO module is configured to process LOCAMO data to determine data, hereinafter also referred to as travel data, identifying location and mode of transportation that a user uses to move from place to place as a function of time. Optionally, the LOCAMO module is configured to determine travel data in real time. The billing module is configured to bill the user for use of the modes of transportation based on the user travel data provided by the LOCAMO module.

In an embodiment UMOM comprises an, optionally cloud based, hub having at least a portion of the software and hardware, including a processor operating in accordance with a set of instructions and data stored in a memory, that supports functions such as optionally those of the LOCAMO module and billing module. At least a portion of the software and hardware, such as a LOCAMO tracker and software that the tracker may use may be comprised in a mobile device such as a smartphone that is carried by the user, comprised in a transportation mode vehicle, or located at a transportation mode transfer node.

In an embodiment, the at least one LOCAMO tracker comprises one or more tracking modules such as a mobile phone triangulation system and/or global navigation satellite system (GNSS) receiver, and optionally an inertial measurement unit (IMU),that may provide location and/or motion data useable to determine the user's location and movement. In an embodiment the at least one LOCAMO tracker may comprise at least one signaling apparatus operable to exchange or receive signals with another signaling apparatus to track location and/or movement of the user. Optionally, the at least one signaling apparatus comprises an RFID reader and/or RFID tag operable to communicate with a RFID tag or reader that identifies a user's location, which may be a static location for example location of a transfer node such as a MIMOT depot, TOD or PTS station where a user may transfer between vehicles and/or transportation nodes, or a movable location such as a location of a vehicle that is boarded by the user. A signal may be image-based, in which case the LOCAMO tracker may comprise a scanner or camera signal. The image-based signal may be a bar code or a QR code encoding identification data. Optionally, the camera is operatively connected to a visual object recognition module, which may derive signals from images of individual passengers, vehicles, or transit stations based on their respective visual features. Optionally, the at least one LOCAMO tracker comprises or is operatively connected to a network communication module configured to transmit LOCAMO data collected by the LOCAMO tracker to a remote hub.

In an embodiment the LOCAMO module, hardware and/or software components of which may be comprised in a LOCAMO tracker and/or in a remote hub, processes LOCAMO data to determine a time resolved feature vector, hereinafter also referred to as a travel feature vector, that may be classified to identify what modes of transportation the user uses, where, when and for how long the user uses each of the transportation modes. At a given time, a travel feature vector may comprise a time stamp, location, components of a velocity vector that determines direction and magnitude of motion of the user, and travel context data. Travel context data optionally comprises data defining features of an environment of a location through which the user is moving, and/or elements of a personal profile relevant to determining or characterizing the user use of a mode of transportation. Travel context data may comprise data that define whether the user is moving through an urban or suburban environment, and whether the user is at a transportation mode transfer node, such as a MIMOT depot, TOD or PTS station. Aspects of the LOCAMO data, such as the travel feature vector, may be stored in the remote hub and optionally used to generate a history of travel activity.

In an embodiment the LOCAMO module processes travel feature vectors to identify discontinuities in motion of the user to determine when the user boards or alights from a transportation mode vehicle and to determine when the user changes a mode of transportation.

The billing module operates to bill the user for use of transportation modes based on travel data that the LOCAMO module provides for the user and optionally on a U-MOM transportation mode billing plan to which the user subscribes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale

FIG. 1 schematically shows an embodiment of a UMOM system in accordance with an embodiment of the disclosure for tracking user travel across multiple travel modes;

FIG. 2 schematically shows a bus at a bus stop, and two passengers, each respectively equipped with a LOCAMO tracker in accordance with an embodiment of the disclosure for tracking the users' travel;

FIG. 3 shows a flowchart describing a UMOM process in accordance with an embodiment of the disclosure;

FIG. 4A-FIG. 4B shows a table listing a series of movement feature vectors (MFVs) providing a time-resolved history of a traveler's travel activity with respect to transportation vehicles in accordance with an embodiment of the disclosure;

FIG. 5 shows a table listing a series of travel segment feature vectors (TrSFs) corresponding to the traveler's ridership of different transportation vehicles during the trip;

FIG. 6 schematically shows a trip summary sent to a traveler's smartphone in accordance with an embodiment of the disclosure;

FIG. 7A shows a table listing a series of vehicle travel features vectors (VTFVs) providing a time-resolved history of an example transportation vehicle's travel and passenger boarding and alighting along a service route;

FIG. 7B shows a table listing a series of vehicle boarding features vectors (VBFVs) providing a time-resolved history of passengers alighting and boarding the vehicle at east transfer node;

FIG. 8 shows a table listing a series of travel node feature vectors (TNFVs) providing a time-resolved history of the presence of transportation vehicles and passengers at an example transfer node; and

FIG. 9 schematically shows a UMOM together with various transportation system participants that interact with the UMOM.

### DETAILED DESCRIPTION

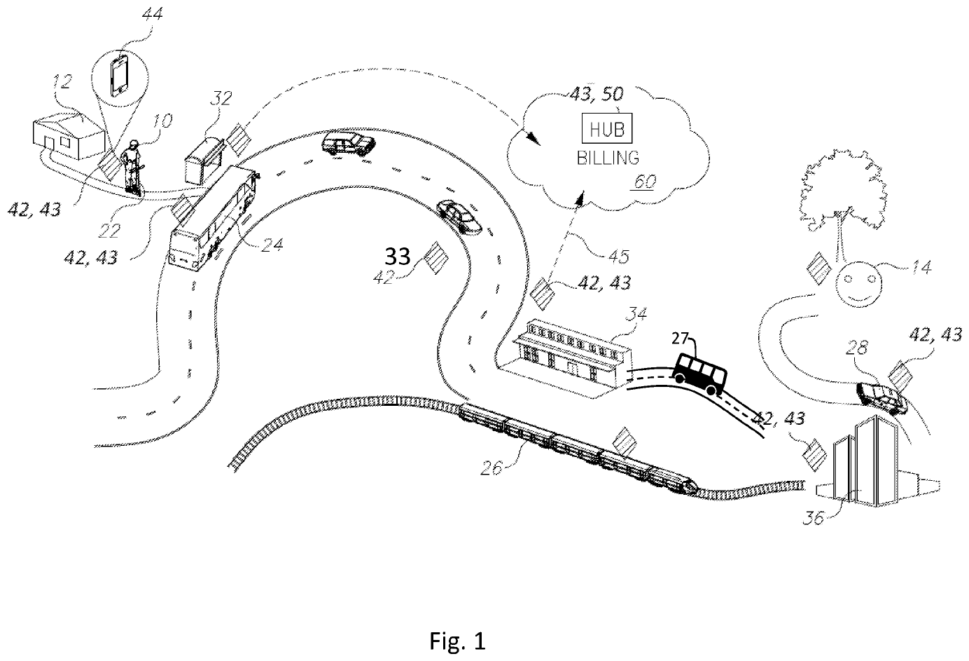

As shown schematically in FIG. 1, A UMOM 5 comprises a plurality of LOCAMO trackers 42 respectively associated physically with a plurality of transportation elements, which may be a user, a vehicle or a transfer node. As shown in FIG. 1, a LOCAMO tracker may be comprised in a mobile device such as a smartphone 44 carried by passenger 10, who may be referred to here as “John”. Alternatively or additional, a LOCAMO tracker may respectively be mounted or integrated into various vehicles of different transportation modes, by way of example dockless scooter 10, bus 24, train 26, and ordered car 28. FIG. 1 also shows by way of example a plurality of LOCAMO trackers 42 respectively that may be respectively mounted on or located at a plurality of transfer nodes such as bus stop 32, bus/train depot 34, and train terminal 36.

By way of example, as shown in FIG. 1, John, who is equipped with a LOCAMO tracker 42 comprised by way of example in his smartphone 44, is shown traveling from his home 12 to his destination 14, a municipal park, by using four different transportation modes. First, he gets on a dockless scooter 22 found near his home to bus station 32, where he boards bus 24 and rides it train/bus depot 34. He then boards trains 26 and rides it to train terminal 36. As John travels to his destination, the LOCAMO tracker comprised in smartphone 44, alone or together with other LOCAMO trackers mounted on one or more of the vehicles he rides and/or the transfer points he traverses, provides LOCAMO data, which may be used to determine location and/or motion of the user as a function of time, to a LOCAMO module 43. LOCAMO module 43 processes the LOCAMO data, and optionally additional data, to determine travel data, such as data processible to determine a travel route that John is traveling between an origin and a destination, detecting John's vehicle boarding and alighting, and identifying one or more transportation legs within the route John traveled on a given vehicle of a given transportation mode. The travel data may then be used by a billing module 54, optionally comprised in hub 50 to calculate total a fee for the trip. Optionally, billing module 54 calculates the fee retrospectively after the trip is complete, taking in account all of the transportation modes utilized by the user during the trip.

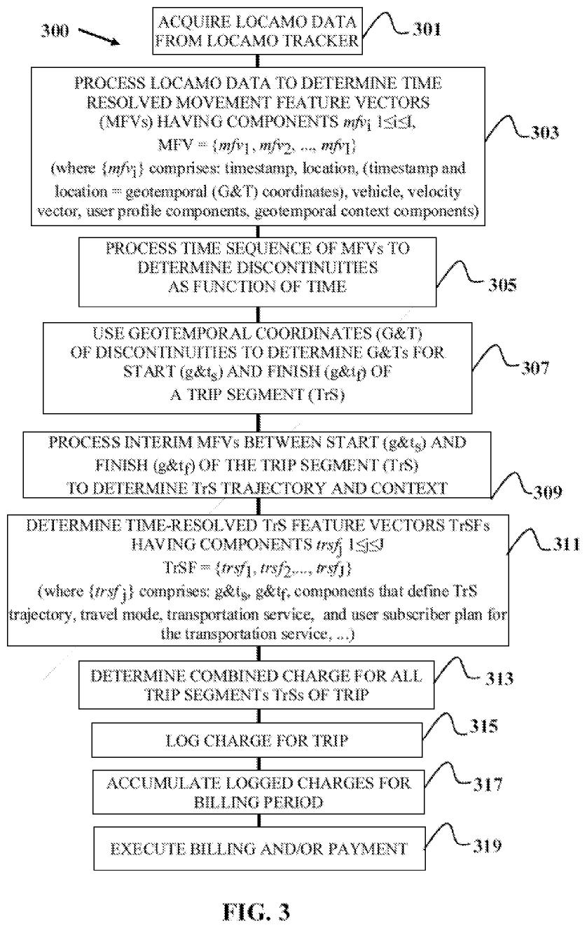

Reference is made to FIG. 3 showing a flowchart 300 of a UMOM method that may be performed by a LOCAMO module 34 to process LOCAMO data provided by the one or more LOCAMO trackers. Components of LOCAMO module 43 may be comprised in a LOCAMO tracker 42 and/or remote hub 50. The LOCAMO tracker comprised in smartphone 44 may be a “networked LOCAMO tracker” that is operatively connected to a network communications module, such as for 3G or 4G cellular wireless communication module comprised in the smartphone, and is configured to transmit LOCAMO data to remote hub 50 via a communications network 60. At least a portion of other LOCAMO trackers may also be a networked LOCAMO tracker.

In a block 301, UMOM process 300 comprises acquiring LOCAMO data from one or more LOCAMO trackers that can be used to determine a user's location as a function of time. LOCAMO data may include geotemporal (GEOTEMP) data used to determine a user's route during a trip in terms of geographical coordinates (such as latitude and longitude) and/or motion of the user at different points in time. LOCAMO data may also include travel context (TRAVCON) data components that can be used to provide information about the user's surroundings at a given time that may or may not be tied to a particular geographic location.

A LOCAMO tracker may comprise or be operatively connected to an IMU.

A LOCAMO tracker may comprise or be operatively connected to a variety of sensors to collect signals (“microenvironment signals”) characterizing a local area surrounding the LOCAMO tracker, by way of example ambient sound, ambient light, images, and radio frequency (RF) signals. Various microenvironment data may be received by an appropriate signal receiver comprised in or operatively connected to the LOCAMO tracker to indicate proximity to other nearby objects, by way of example objects that comprise an RF signal source.

As used herein, a device comprised or operatively connected to a LOCAMO tracker that is configured to receive one or more modes of a microenvironment signal may be referred to herein as a “signal receiver” that is configured to receive a signal from a “signal source”. A “signal apparatus” as used herein may refer to a device or object that comprised a signal receiver and/or a signal source. In a case where microenvironment signal is an RF signal, the signal source may be, by way of example, a an RFID tag, a contactless smartcard (optionally a “medium range smartcard” under an ISO 15693 standard allowing 0.5-1.5 m read range), a two-way NFC device, a Wi-Fi terminal, a millimeter wavelength (“mmWave”) antenna-equipped terminal, or a Bluetooth-enabled device, a and the signal receiver may be, by way of example, an RFID reader, a contactless smartcard reader, two-way NFC device, a Wi-Fi access point, a mmWave access point, or a Bluetooth-enabled device. A signal receiver may be a global navigation satellite system (GNSS) signal receiver operable to receive signals from a GNSS satellite serving as a signal source. A signal may be image-based, in which case the signal source may be an image, by way of example, a bar code or a QR code encoding identification data and the signal receiver may comprise a scanner or camera operatively connected to an image processing module that is configured to determine identification data encoded in an image. Optionally, the signal receiver comprises a camera operatively connected to a visual object recognition module configured to recognize individual passengers, vehicles, or transit stations based on their respective visual features.

Certain RF signals received by a LOCAMO tracker may provide GEOTEMP data. By way of example, various methods of location tracking based on RF signals are known, including multilateration (and in some cases triangulation) of: RF signals between cell towers of communication networks and mobile phones; GNSS RF signal received from GNSS satellites; and Wi-Fi RF signals received from Wi-Fi hotspots and access points associated with known locations. In addition, IMU data, with or without location tracing, can be processed to determine acceleration and/or velocity at given time points.

Certain RF signals received by a LOCAMO tracker may provide TRAVCON data. In an embodiment, a signal received by a signal receiver may comprise a unique identifier that is associated with a particular user of the UMOM, a transportation service, a PTS route, a transportation vehicle, or a transfer node. Such a signal comprising a unique identifier may be referred to herein as an “ID signal”. An RF signal that comprises an identifier to function as an ID signal may be referred to herein as an “RFID signal”). By way of example, an RFID signal may be an BSSID (MAC address) of a Wi-Fi access point comprised in a transportation vehicle or located at a transfer node may serve as an ID signal for the particular vehicle or transfer node, respectively. Depending on the method access point deployment, an SSID of a Wi-Fi access point may serve, by way of example, as an RFID signal for a particular vehicle, or a transportation service operating a plurality of vehicles including the vehicle with the access point. Other RF signals may also serve as an RFID signal, including NFC signals, mmWave signals, and Bluetooth signals. In an optical modality, bar codes and QR codes may serve as ID signals, and given a camera connected to a visual object recognition module, other visual features that are not specifically deployed to serve as ID signal sources, such as objects, displays, signs, and biometric features may nevertheless serve as sources of ID signals.

In a case where TRAVCON data is associated with a moving object, such as an ID signal from a vehicle-mounted Wi-Fi access point, the ID signal may not be associated with a geographical location. Other inputs such as ambient light level or ambient sound that can serve as TRAVCON data may not be associated with a geographical location. Nevertheless, TRAVCON data, when analyzed in combination with GEOTEMP data determined through other signals by a LOCAMO tracker, may be valuable in determining features of a user's trip such as determining segments of vehicular travel of a user's trip, and identifying vehicles ridden by the user and/or transportation services operating the vehicles. It will be appreciated that some signals, by way of example Wi-Fi signals from hotspots mounted on stationary objects such as a bus stop and associated with a known geographical location, may be processed to provide both TRAVCON data and GEOTEMP data.

In a block 303, the LOCAMO module processes the LOCAMO data, which may include

GEOTEMP data and TRAVCON data, to provide a plurality of time-resolved movement feature vectors MFVs providing a geotemporal record of a user's trip. An MFV may have components mfvᵢ 1≤i≤I, expressed as:

MFV={mfv₁, mfv₂, . . . , mfv_{I}}

where {mfvᵢ} may comprise: GEOTEMP data such as a timestamp, a geographical location, and a velocity vector, as well as TRAVCON data, such as user profile components, environmental data components, and properties of ID signals. A time-resolved sequence of a plurality of MFVs may serve as a geotemporal record of the user's trip, which can be subsequently processed to detect discontinuities in travel-relevant details of the user's trip for identifying the beginning and end of vehicle-based trip segments in which the user boarded and rode on a vehicle as part of trip.

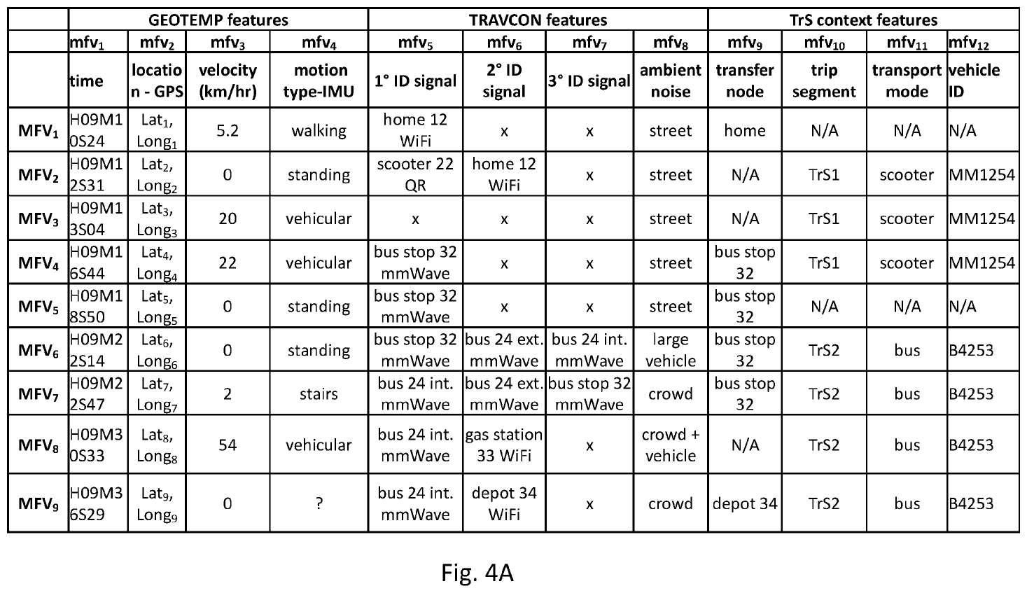

Reference is made to FIGS. 4A and 4B, showing an example set of MFVs, MFV₁ to MFV₁₉ in a table format, characterizing key steps along John's multimodal travel as shown in FIG. 1. Each MFV includes four GEOTEMP features: a timestamp (mfv₁), GPS-based location (mfv₂), velocity optionally derived from GPS and/or IMU (mfv₃), motion type—standing, walking, running, stairs, wheeled vehicular motion, or idling in vehicle—determined responsive to IMU signals (mfv₄). Each MFV also includes four TRAVCON features: up to three ID signals (mfv₃ through mfv₇) received from various sources, and a characterization of ambient noise based on sound recorded from a microphone operably connected to John's smartphone 44.

As shown by way of example in FIGS. 4A-4B, each of mfv's mfv₁ through mfv₇ may be based on signals received or generated by smartphone 44. However, an MFV can include features received or generated by other LOCAMO trackers, by way of example those mounted on buses transit stops that interfaced and exchanged data such as ID signals with John's smartphone during the trip.

As can be seen in FIGS. 3A-3B, the nineteen MFVs provide a running, time-resolved commentary of John's trip from his house to his destination 14, a national park, as follows:

MFV₁: John is leaving house 12;
MFV₂: John is unlocking scooter 22 by having smartphone 44 capture a QR code on the scooter;
MFV₃: John is riding scooter 22;
MFV₄: John is approaching bus stop 32 on scooter 22;
MFV₅: John is waiting for a bus at bus stop 32;
MFV₆: Bus 24 is approaching bus stop 32;
MFV₇: John is boarding bus 24 at bus stop 32;
MFV₈: John is riding bus 24, which passes gas station 33;
MFV₉: John is moving towards the exit to get off bus 24 at bus/train depot 34;
MFV₁₀: John is alighting bus 24 at bus/train depot 34;
MFV₁₁: John walking towards a train platform at bus/train depot 34;
MFV₁₂: Train 26 is arriving at the train platform;
MFV₁₃: Train 26 is leaving bus/train depot 34;
MFV₁₄: John is riding on train 26 going full speed;
MFV₁₅: John is getting off of train 26 at terminal 36;
MFV₁₆: John is walking through terminal 36 and ordering a TOD car 28;
MFV₁₇: John is getting into TOD car 28;
MFV₁₈: John is riding on TOD car 28;
MFV₁₉: TOD car 28 arrives at national part 14.

An MFV at a given timepoint may be locally generated by LOCAMO tracker 42 and LOCAMO module 43 comprised in smartphone 44, then transmitted to hub 50 if and when a cell-based communication channel is available. Collecting, locally processing, and transmitting MFV features imposes a cost on power consumption, processing power, and communication channels available to smartphone 44. Therefore, the generation of MFVs may be limited based on phone status, as well as the travel status as indicated by way of example by previous MFVs.

By way of example, a LOCAMO module may generate a new MFV at a default rate of about once every minute, once every two minutes, once every five minutes, or the like, but may increase the rate of new MFV generation if the previous one or more MFV indicates likelihood of an ongoing or imminent action by the traveler that is relevant to tracking multimodal travel, such as a change in the presence of ID signals indicating a possible transfer. By way of example, MFV2 indicates that smartphone 44 registered a QR code for a sharable scooter. Whereas the previous MFV (MFV1) was generated 2 minutes prior, the following MFV of MFV3 was generated sooner, only about 30 seconds later, so that the LOCAMO module creates a finer grain record of John's travel to better ascertain that a change in travel module, in this case a transition from walking to riding a scooter, can be ascertained with better accuracy and confidence. Similarly, when MFV6 indicates that smartphone 44 registered an mmWave signal from bus stop 32, and two mmWave signals from bus 24, thus indicating a bus approaching at the bus stop where John is waiting, LOCAMO module may increase the rate of new MFV generation. As such, as shown, the following MFV7 is timestamped 33 seconds after MFV6.

In a block 305, the LOCAMO module may processes an MFV to detect discontinuities in one or more MFV features mfv as a function of time for determining changes in travel mode during the trip.

A change in travel modes may be detected based of one or more trip discontinuities. A user that is walking, standing, or riding a vehicle of different transportation modes may be characterized by different parameters of motion, by way of example velocity (as indicated in the MFVs with feature mfv₃) and patterns of inertial data as measured by an IMU. LOCAMO module may process the inertial data to determine a motion type (mfv₄) of the user at various time points, such as whether the user is standing, walking or riding a transportation vehicle based on IMU readings. The inertial data may be used to differentiate between particular types of transportation vehicle as well. By of example a bus ride may provide an inertial data pattern that is distinct from a car or a train. The LOCAMO module processes MFVs may detect discontinuities in movement pattern as indicating a transfer between transportation modes, such as between walking and vehicular transportation, or from one form of vehicular transportation to another. See, for example the transition in mfv₄ between MFV₂ and MFV₃. The LOCAMO module may determine a change in velocity of a user, by way of example from about 5 kilometers per hour (km/h) in a first timepoint to about 30 km/h in a subsequent as indicating that a user transitioned from walking to riding a vehicle (see, for example the transition in velocity between MFV₁₁ and MFV₁₃). The LOCAMO module may identify a period of stationary non-movement or standing prior traveling at about 40 km/hour as indicating waiting for a vehicle, then boarding the vehicle. Optionally, IMU data may be processed to detect movements characteristic of to a user boarding or alighting a vehicle. See, for example, MFV₇, in which the IMU readings (mfv₄) are interpreted to detect movement on a staircase.

A LOCAMO module may determine discontinuities in reception of ID signals as indicating a change in travel mode. By way of example, a change in strength of an ID signal transferred between a user and a vehicle may indicate vehicle boarding or alighting, and a change in an ID signal transferred between user and a transfer node may indicate a user's arrival at or departure from a transfer node. See for example the changes in signal strength of the ID signals for bus stop 32 and bus 24 between MFV₆ and MFV₇.

A LOCAMO tracker may be configured so that detection of an ID signal may be passive, in that a distinct action by the passenger to have his boarding and alighting registered is not required. It will be appreciated that, for many modalities of ID signals, a signal receiver may be operable to receive a signal from a signal source at a distance that is close enough to indicate physical proximity, which may be less than 2 meters, or less than 5 meters, but far enough, optionally more than 0.5 meters or more than meter, to not require a passenger to make an intentional act to present, transmit, or receive an ID signal.

In a block 307, the LOCAMO module may designate a portion of the trip characterized in a time sequence of MFVs as a trip segment (TrS) based on geotemporal coordinates (geographic location and timestamp; “G&T”) of the changes in travel mode. A G&T of a first travel mode discontinuity may be designated as a start G&T (g&tₛ) of a TrS, and a G&T of a second travel mode discontinuity may be designated as a finish G&T (g&t_{f}) of the TrS. A multimodal trip in which a user uses more than one transportation vehicle between an origin and a destination may comprise multiple TrSs, each TrS corresponding to one of the travel vehicles.

By way of example, as shown in the MFV table in FIGS. 4A-4B, the LOCAMO module processes the various discontinuities in the features of MFVs 1 through 19 and selects MFV₂ as indicating the g&tₛ and MFV₄ as indicating the g&t_{f} of the first travel segment TrS1 (on the scooter) of Johns trip to national part 14. For TrS2 on bus 24, the LOCAMO module selects MFV₆ as indicating the g&tₛ and MFV₉ as indicating the g&t_{f}. For TrS3 on train 26, the LOCAMO module selects MFV₁₂ as indicating the g&tₛ and MFV₁₅ as indicating the g&t_{f}. For TrS3 on TOD car 28, the LOCAMO module selects MFV₁₇ as indicating the g&tₛ and MFV₁₉ as indicating the g&t_{f}. The LOCAMO module then adds the respective TrSs designation for each MFV as mfv₁₀.

In a block 309, the LOCAMO module may process interim MFVs having timestamps between g&tₛ and g&t_{f} to determine a trajectory of the route of the TrS and/or optionally one or more context features characterizing the TrS. Context features for a TrS may include travel mode, transportation service, and user subscriber plan for the transportation service. In a case where a travel mode of a given TrS is a PTS mode, the context features may include a transportation service line as well as boarding and alighting transfer nodes used by the user. By way of example, if a given TrS is determined to be a bus segment, the context features may include the following features: transportation service=Metropoline Bus Company; transportation service line=bus line 605 connecting Netanya and Tel Aviv; boarding transfer node=Netanya Central Bus Station; alighting transfer node=bus station at corner of Namir Rd. and Einstein Rd. in Tel Aviv. The determining of the TrS features may be accomplished through a rules-based approach of processing the MFVs with pre-defined classification rules, and/or through processing the MFVs with classifiers such as a decision tree, a Support Vector Machine (SVM), a Random Forest classifier and/or a Nearest Neighbor classifier. The classifier may be a neural network trained through a machine learning process with appropriate training data.

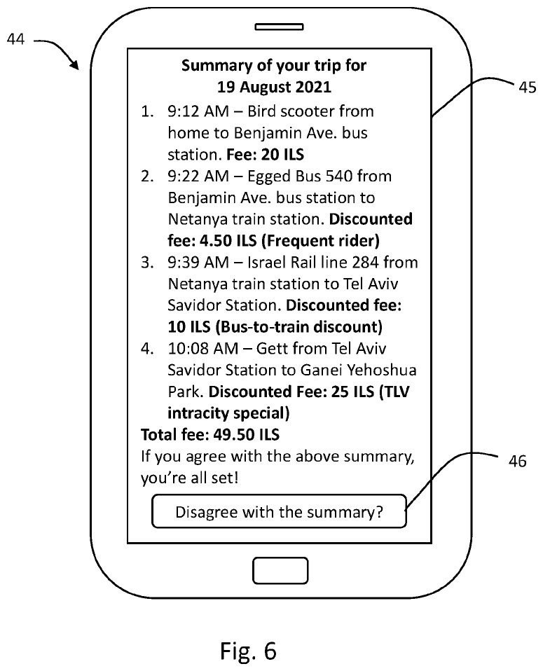

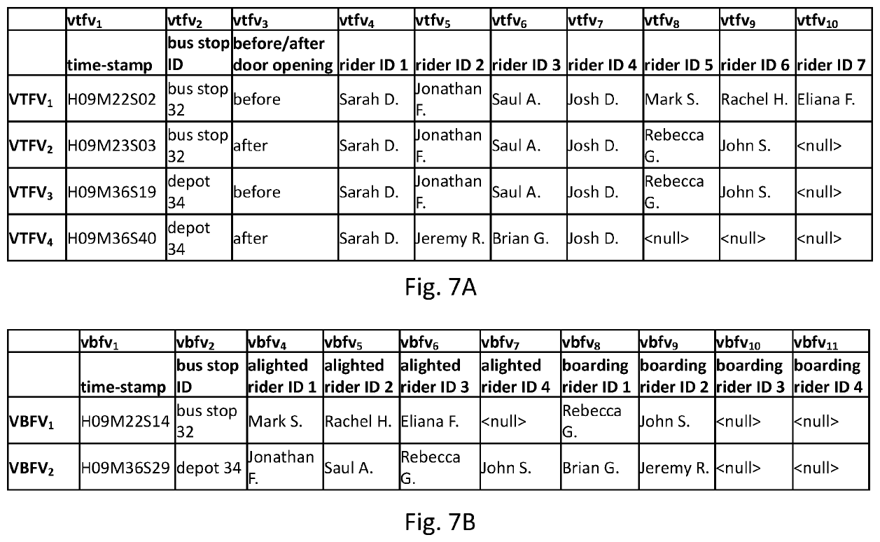

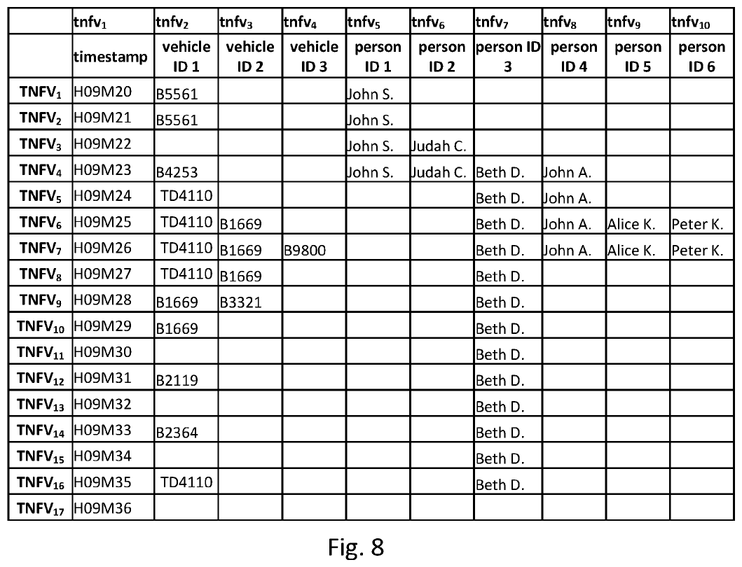

In order to determine the TrS context features, the LOCAMO module may cross-reference TrS features determined from the interim MFVs, which may include or be based on TRAVCON data comprised in the MFVs, against a repository of transportation data optionally stored at hub 50. The transportation data repository may include schedules of PTS routes, known time-resolved locations of LOCAMO-tracked transportation vehicles, and/or known locations of transfer nodes. The transportation data repository may include a history of past travel activity previously collected by LOCAMO trackers and stored at hub 50. The history of past travel activity may include data responsive to MFVs collected previously from the same user or other users. The history of past travel activity may include data responsive to time-resolved vehicle travel feature vectors (VTFVs), optionally collected from vehicle-mounted LOCAMO-modules and shown by way of example in FIG. 7, that provide a record of passengers riding a given vehicle as well as transfer nodes traversed by the vehicle. The history of past travel activity may include data responsive to transfer node feature vectors (TNFVs), optionally collected of transfer node-mounded LOCAMO-modules and shown by way of example in FIG. 8, that provide a record of passengers and vehicles traversing a given transfer node.

Optionally, the cross-referencing against the transportation data repository is represented as additional features in the travel feature vector. The travel feature vector, optionally with the transportation data repository, maybe processed to resolve a transportation mode, a transportation service provider, a transportation service route, or a vehicle associated with one or more segments (“legs”) of the travel route.

By way of example, the GPS location of smartphone 44 and/or ID signals received by smartphone 44 at the respective g&tₛ and g&t_{f} of each TrS may be compared against the known transfer nodes to identify a transfer node where a given TrS started and ended. As shown in FIGS. 4A-4B, the result of the comparison is added to the MFVs as feature mfv₉. By way of example, the starting transfer node and the finishing transfer node for TrS2 is indicated to be bus stop 32 and depot 34, respectively, and starting transfer node and the finishing transfer node for TrS2 is indicated to be depot 34 and terminal 36, respectively. A TrS in which the transportation mode is a PTS will typically start and end at a transfer node. However, a TOD- or MIMOT-based transportation mode is not limited to particular start and finish locations and thus may start and finish at locations that do not correspond with known transfer nodes (see by way of example MFV₂ and MFV₁₉).

As shown in FIGS. 4A-4B, the LOCAMO modules resolves the transportation mode (mfv₁₁) and vehicle ID (mfv₁₂) associated with each of the four TrSs comprised in John's trip. For TrS1, the transportation mode of a MIMOT scooter is detected based a combination of on the QR code registered by smartphone 44 when activating scooter 22 as recorded in MFV₂ and the speed of 20 km/hr or 22 km/hr achieved at MFV₃ and MFV₄, respectively, and the vehicle ID is detected based on the QR code. For TrS2, the transportation mode of a bus and the vehicle ID is detected based on the bus's ID signal received by smartphone 44 via an mmWave-based communication.

In some cases, different TrS routes may be possible given a pair of g&tₛ and g&t_{f}, and optionally other TrS features, and it would be to resolve a correct TrS route given the data available to the LOCAMO module. In some cases, one or more of the discontinuities in a MFV detected in block 305 may be a spurious detection that does not actually represent a change in travel mode, and it may be advantageous to ascertain the discontinuity. Optionally, a LOCAMO module generates a plurality of potential TrS routes based on a given pair of g&tₛ and g&t_{f} of a TrS determined in block 307 and the transportation data repository. The potential TrS routes may then be compared against the TrS features derived from the MFVs to derive additional context features, and/or confirm existing context features describing the travel mode of the TrS, in order to narrow down to a single possible, or most likely, TrS given the all of the relevant context features.

By way of example, for TrS3, smartphone 44 received no vehicle-specific ID signals, and the LOCAMO module detected the transportation mode and vehicle ID of train 26 through less direct means. Multiple transportation modes, including a train line, multiple bus lines, and TOD cars, can be used to travel from depot 34 to terminal 36. By way of example, after the trip or trip segment is completed, the LOCAMO module compares the start time of H09M39S14 and the finish time of H10M05S36 against the record of buses and train that traveled between depot 34 and terminal 36 within the same time period and determines that the travel record of both train 26 and bus 27 are consistent with the g&tₛ and g&t_{f} of TrS3, thus presenting multiple possible alternative trip segments. Responsive to the presence of multiple possible routes, the LOCAMO module compared the trajectory of TrS3 as determined by the GPS locations registered with the MFVs assigned to TrS3 against the known routes of train 26 and bus 27 respectively, as stored in the transportation data repository comprised in hub 50. With respect to TrS3, the GPS location of smartphone 44 carried by John as registered in intervening MFV₁₄ (Lat₁₄, Long₁₄) is consistent with the known route of train 26 but not with the known route of bus 27. The LOCAMO module therefore assigns train 26 to TrS3 and populates the transport mode (mfv11) with “train” and populates the vehicle ID (mfv12) with a vehicle ID (“T3985”) associated with train 26 within the transportation data repository.

Optionally, by way of example where the LOCAMO module detects multiple alternative TrSs for a given g&tₛ for a given g&tₛ and g&t_{f} pair, the LOCAMO module may generate or transmit to smartphone 44 a message prompting the user to provide additional information sufficient to resolve the TrS, including by way of example identify the transit vehicle or transit line for the TrS. By way of example, upon detecting the g&tₛ for TrS3 and determining that TrS3 may a train segment on train T3985 (see FIG. 4B, MFV₁₂) the LOCAMO module may transmit a message to smartphone 44 stating: “Our system indicates that you got on train T3985 to Tel Aviv—please confirm”, with a response option for the user to confirm, or provide alternative transportation information if incorrect.

In a block 311, the TrS features determined in block 309 may be processed to determine time-resolved TrS feature vectors (TrSFs) having components trsfⱼ 1≤j≤J, TrSF={trsf₁, trsf₂, . . . , trsf_{J}}, where {trsfⱼ} may include spatiotemporal features of a TrS such as g&tₛ, g&t_{f}, and components that define TrS trajectory, as well as TrS context features such as travel mode, transportation service, and user subscriber plan for the transportation service. A TrSF representing a given user's travel may be stored in remote hub 50 as part of the transportation data repository to be used for analysis of subsequent LOCAMO data and MFVs.

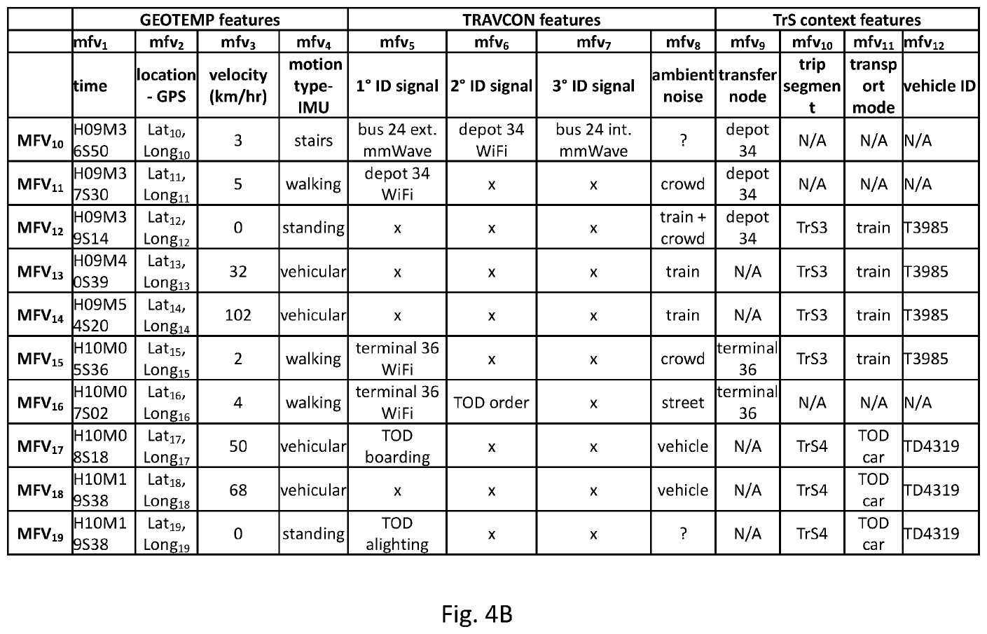

Reference is made to FIG. 5, which shows a TrSF table listing the TrSFs 1 through 4 describing each of TrSs 1 through 4 comprised in John's travel between home 12 and destination 14 as identified by LOCAMO module 43. Each TrSF as shown in FIG. 5 comprises the following features: transportation mode (trsf₁); TrS start time (trsf₂); TrS start location (trsf₃);TrS end time (trsf₄); TrS end location (trsf₅); vehicle ID of the vehicle carrying the passenger in the TrS (trsf₆); ID of the transportation service operating the vehicle associated with the TrS (trsf₇); and a service line of the transportation service (trsf₈).

A travel duration for each TrS may be calculated by subtracting the start time from the end time, and the service and line IDs may be determined based on the vehicle ID and the transportation data repository stored in hub 50. As shown in FIG. 5, the four TrSFs determined by the LOCAMO module for John's trip indicates that the trip had the following four TrSs: TrS1 in which John traveled on a dockless scooter operated by Bird for 4 minutes and 14 seconds to bus stop 32; TrS2 in which John traveled on bus line 540 operated by the Egged® Bus Corporation for 14 minutes and 15 seconds to depot 34; TrS3 in which John traveled on train line 284 operated by Israel Rail for 26 minutes 22 seconds to terminal 36; and TrS4 in which John traveled on a TOD Car operated by Gett® for 11 minutes 20 seconds to final destination 14, the national park.

In a block 313, billing module 54 optionally comprised in Hub 50 may process a time sequence of TrSFs of a user's trip to calculate a charge for the trip. The total fee may be based on cross-referencing the time sequence of TrSFs against a stored set of fee schedules for a plurality of transportation services. Optionally, billing module 54 periodically communicates with a plurality of transportation services, by way of example via APIs, to maintain an updated fee schedule for each transportation service that is supported by the UMOM. A fee schedule may be dynamic, and based on a plurality of parameters, including travel times, a count of other passengers in a same vehicle, use of particular transfer nodes, personal status of the user, and the like. By way of example, a fee schedule may indicate charging a different fee in a same trip segment depending of whether to user is a senior citizen, a child, a student, or a standard user. Advantageously, special promotions to increase ridership generally, or to direct passengers towards less popular travel times, routes, or transfer nodes to reduce congesting, may be implemented by reprogramming the fee schedule. The fee schedule may be dynamically reprogrammed to reflect current traffic or congesting status, or the abundance of other riders in individual transit vehicles. By way of example, a user may be offered a discounted price to travel in a less popular time, transit vehicle, or transit line, or charged a premium price to travel in a more popular time, transit vehicle, or transit line. Volume discount, such as a monthly pass or a family discount in the case of multiple family members traveling together, may be implemented automatically upon the usage reaching a threshold, and a passenger may be alerted that they are approaching a volume discount threshold.

Reference is made to FIG. 5. As shown in the TrSF table for John's trip, billing module 54 processes TrSFs 1 through 4 to assign a fee for each TrS. For each TrS, the billing module calculates a base fee that is recorded as trsf₁₀ in the associated TrSF and an adjusted fee based on contractual agreements between billing parties (passenger, transportation services, UMOM, governmental bodies) that is recorded as trsf₁₁ in the associated TrSF. Each fee is based on the features (trsf 1 through 9) as well as a set of fee schedules stored in hub 50.

For TrSF₁, billing module 54 determines a base fee of 20 Israeli shekels (ILS) for the use of the scooter, based the fee schedule imported from Bird. The billing module further process the TrSFs and determines that no fee adjustments are due, so the adjusted fee (trsf₁₁) remains the same.

For TrSF₂, the billing module determines a base fee of 6 ILS for riding the bus, based on a fee schedule imported from the Egged Bus Company. The billing module further processes John's history of bus ridership collected and recorded as TrSFs by the LOCAMO module over the past two weeks, and determines that John qualifies for a high volume ridership discount of 1.50 ILS and determines the adjusted fee (trsf₁₁) to be 4.50 ILS.

For TrSF₃, the billing module determines a base fee of 15 ILS for riding the train, based on a fee schedule imported from Israel Rail. The billing module further notes a stimulus schedule imported from the Ministry of Transportation (MoT), in which all bus-to-train and train-to-bus transfers receive a 5 ILS discount. Based on the MoT stimulus schedule, the billing module determines the adjusted fee (trsf₁₁) to be 10 ILS.

For TrSF₃, the billing module determines a base fee of 30 ILS for riding the TOD car, based on a fee schedule imported from Gett®. The billing module further registers a municipal promotion schedule entered into hub 50 by the operator of the UMOM based on a contractual agreement with Gett® and the City of Tel Aviv in which all rides with Gett-operated TOD cars are entitled to a maximum intra-city fee of 25 ILS within Tel Aviv city limits. Based on the municipal promotion schedule, the billing module determines the adjusted fee (trsf₁₁) to be 25 ILS.

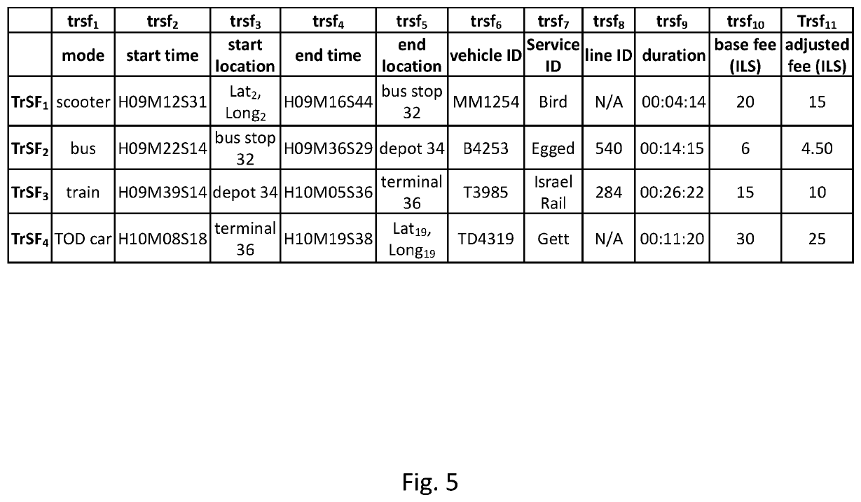

Optionally, LOCAMO module 43 or billing module 54 generates a trip summary based on TrSFs 1 through 4 and transmits the summary for display in smartphone 44. Reference is made to FIG. 6, which schematically shows smartphone 44 displaying on a screen 45 a trip summary 46 summarizing each of TrS 1 through 4 based on the features stores in TrSFs 1 through 4 (as listed in the TrSF table shown in FIG. 6). As shown in FIG. 6, each of listed items 1 through 4 corresponds to TrS 1 through 4 of John's trip as shown in FIG. 1. The list also includes the adjusted fee for each TrS that is recorded as trsf₁₁ for each corresponding TrSF and an explanation of the fee adjustment when applicable. Screen 45 also displays a notification button 46 for a user to indicate disagreement with the summary.

The billing module may also determine payments to be made to a transportation service for providing and operating the vehicle for a given TrS or a trip comprising multiple TrSs, as well as payments to be made to ancillary services also registered with the UMOM. The ancillary services may include payment aggregation services or government entities such as municipalities and national government agencies. In a case where a trip comprises multiple TrSs involving multiple services, the respective payments to be made to the multiple services may be determined based on a number of factors, including charges made to users, as well as a service payment schedule reflecting contractual agreements between the services, which may include the entity operating the UMOM system.

In a block 315, the user charges and optionally service payments determined in block 313 may be logged in a billing database, and in a block 317, the logged charges and payments may be accumulated through a billing period or beyond. The billing period may be a day, a week, a month, or a year, and may be different for different entities. By way of example, a billing period for charging user may be dependent on a user's subscriber plan with a transportation service provider, and a billing period for payment to a service may be based on a contractual agreement between relevant parties and reflected in the service payment schedule. The billing database may be accessible, optionally through an application program interface (API) to third party applications such as applications operated by payment processing companies, by way of example credit card providers and banks, as well as transportation services and ancillary services.

In a block 319, a billing module may execute user billing and/or service payment based on the charges logged and accumulated in blocks 315 and 317. Optionally, the executing may include sending an appropriate notice to users and services, or to execute transfer of funds to and/or from appropriate users and services based on the accumulated charges.

The location of processing, or the division of labor between a local LOCAMO module located at a LOCAMO tracker and a remote LOCAMO module located at hub 50 may be configured to balance processing speed, memory capacity available to a LOCAMO tracker, and power reserves available to a LOCAMO tracker. In a case where a LOCAMO tracker is embedded in a smartphone, which has limited power reserves, it would be advantageous to apportion the processing between LOCAMO tracker instances to minimize local power usage by the LOCAMO tracker. Also in a case where a LOCAMO tracker is embedded in a smartphone, the rate of LOCAMO data collection may be advantageously tuned, or LOCAMO data may be collected in a selective manner, to balance a desire for a higher volume of LOCAMO data on one hand, and for minimizing power usage on the other. Raw LOCAMO data may be transmitted from a networked LOCAMO tracker to be processed by an instance of a LOCAMO module operating in a processor comprised in hub 50. Raw LOCAMO data may be processed in a locally operating instance of a LOCAMO module operating in a processor comprised in the LOCAMO tracker that recorded the LOCAMO data, up through generating or updating an MFV or a TrSF, which may be then transmitted intermittently to hub 50. Optionally, a local instance of the LOCAMO module may pre-process raw LOCAMO data to detect an event or a status usable in generating or updating a MFV and transmitting a notice (“event notice”) comprising relevant information regarding the detected event or status, by way of example a discontinuity in the MFV that indicates or possibly indicates a change in transportation mode, which is then further processed in another instance of a LOCAMO module located at Hub 50 to determine a TrS and generate a TrSF.

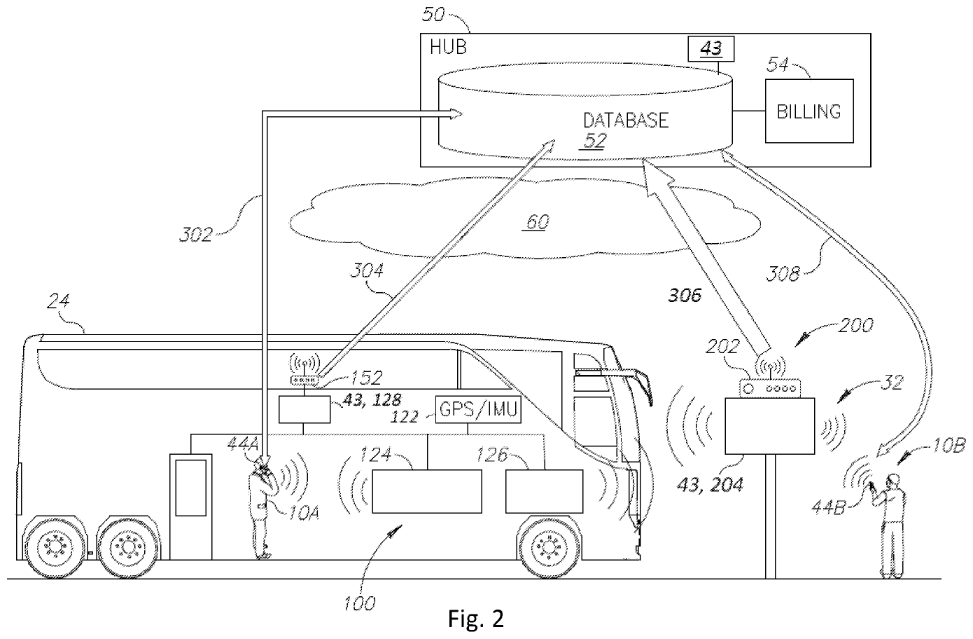

FIG. 2 provides, by way of example, a more detailed schematic view of bus 24 stopped at bus stop 32, showing John, represented as a passenger 10B, carrying a smartphone 44B and waiting at the bus stop for bus 32, and also showing John at a later time point, represented as a passenger 10A carrying a smartphone 44A, having boarded bus 32.

Smartphones 44A and 44B are respectively configured to operate as a networked LOCAMO tracker 42. One or more of a variety of modules embedded in the respective smartphones, such as a mobile phone triangulation system and/or global navigation satellite system (GNSS) receiver, and optionally an inertial measurement unit (IMU), may be controlled to serve as a movement tracking device 45 to provide LOCAMO data useable by a LOCAMO module to determine a time sequence of MFVs. Smartphones 44A and 44B may respectively be configured to control a mic, camera, or RF-based communication modules such as a Wi-Fi module, an NFC module, or a Bluetooth module, to operate as a signal receiver 46 for receiving microenvironment signals characterizing the local area surrounding the respective smartphones. The microenvironment signals may include signal apparatus to exchange ID signals with other LOCAMO trackers, by way example those physically associated with vehicles such as bus 24 or transfer nodes such as bus stop 32. The LOCAMO data, which may include data from the microenvironment signals, may be processed by an instance of a LOCAMO module 43 operating in processor 48 according to a set of instructions and data stored in memory 49 to generate travel data, optionally MFVs. Smartphones 44A and 44B may respectively comprise a network communication module 47 configured to communicate with hub 50 via communication network 60, which may be cellular communication network.

Bus 24 may be equipped with a LOCAMO tracker 100, comprising a processing unit 128 operatively connected to one or more signal apparatuses (SAs), by way of example an inner SA 124 and an outer SA 126, for exchanging ID signals with other LOCAMO trackers, by way of example those physically associated with passengers or transfer nodes. Processing unit 128 may be operatively connected to one or both of network communication module 152 and a bus movement tracking device 122, which may comprise a GNSS unit and/or an IMU. Processing unit 128 may be configured to support operation of an instance of a LOCAMO module 43 according to a set of instructions and data stored in a memory (not shown) to generate travel data, optionally MFVs.

Bus station 32 may be equipped with a transfer node (“X-node”) LOCAMO tracker 200, comprising a processing unit (not shown) operative connected to a SA 204. X-node LOCAMO tracker 200 may further comprise a network communication module 202.

As shown in FIG. 2, as John (as passenger 10B) alights from the dockless electric scooter (shown in FIG. 1), walks to station 32, then stands while waiting for a bus, his smartphone 44B collects LOCAMO data through various channels, for example movement data from a GNSS receiver and an IMU as well as microenvironmental data, which may include a transfer node ID signal identifying bus station 32 from SA 204 comprised in X-node LOCAMO tracker 200. The collected LOCAMO data, or portions thereof, may be transmitted via communication channel 308 to a database 52, and processed by an instance of a LOCAMO module to generate or update MFVs describing John's trip thus far. Aspects of the collected LOCAMO data may be processed by a local instance of the LOCAMO module operating in smartphone 44B to detect events relevant to transportation. By way of example, a waiting notice may be generated through an exchange of respective ID signals between smartphone 44B and station-mounted SA 204 comprised in X-node LOCAMO tracker 200, to be transmitted to database 52 by smartphone 44B. The collected LOCAMO data or portions thereof may be stored in database 52 so that database 52 maintains a travel history of John, as well as the travel history of other users.

When bus 24 arrives, John (as passenger 10A) boards the bus to continue his trip. As John boards, the bus, his smartphone (now smartphone 44A) continues to collect LOCAMO data, which may include GNSS and IMU-based movement data, as well as microenvironmental data, which may include a bus ID signal identifying bus 24 from inner SA 124 comprised in bus LOCAMO tracker 100. The collected LOCAMO data, or portions thereof, may be transmitted via communication channel 302 to database 52, and processed by an instance of a LOCAMO module to further update the time sequence of MFVs describing John's trip. Aspects of the collected LOCAMO data may be processed by a local instance of the LOCAMO module operating in smartphone 44A to detect events relevant to transportation. By way of example, a boarding notice may be generated through an exchange of respective ID signals between smartphone 44A and inner SA 124 comprised in bus LOCAMO tracker 100, to be transmitted to database 52 by smartphone 44B. Additionally, once John boards the bus, or after the bus drives away from bus station 32, station ID signal from SA 204 comprised in X-node LOCAMO tracker 200, which had until then been received intermittently by the smartphone, will attenuate in signal strength and eventually terminate. An instance of the LOCAMO module operating in the smartphone may detect this signal attenuation and transmit an event notice to database 52 indicating that John as left bus station 32. These event notices can be processed by an instance of a LOCAMO module operating at hub 50 to generate and/or update the time sequence of MFVs describing John's trip.

Feature vectors have been described hereinabove (by way of example in FIGS. 4A-4B and 5) primarily as describing a trip from the perspective of one passenger responsive primarily to LOCAMO data collected by a LOCAMO tracker physically associated with the passenger. That being said, the present disclosure also includes vehicle travel feature vectors that describe a trip from the perspective of a vehicle responsive to LOCAMO data collected by a LOCAMO tracker physically associated the vehicle, by way of example LOCAMO tracker 100 comprised in bus 24. A time-resolved set of vehicle travel feature vectors describing bus 24 may be based on LOCAMO tracker 100 collecting movement data based on bus movement tracking device 122, as well as microenvironment data collected by inner SA 124 and outer SA 126. The microenvironment signals may include passenger ID signals received from the passengers boarding the bus during its travel as well as transfer node ID signals received from SAs located at the bus stops, by way of example bus stop 32, that bus 24 makes its stops. The LOCAMO data collected by bus LOCAMO tracker 100, as well as event notices generated by the bus LOCAMO tracker, may be processed locally to generate time-resolved vehicle travel feature vectors (VTFVs), and periodically transmitted to database 52 by network communications module 152 via communications channel 304. Alternatively, the LOCAMO data and event notices may be transmitted to database 52 to be used for processing by a remote LOCAMO module operating at hub 50 to generate the VTFVs. VTFVs or aspects thereof may be stored in remote hub 50 as part of the transportation data repository to be used for analysis of subsequent LOCAMO data.

By way of example, bus 24 may comprise a plurality of inner SAs 124 placed within the bus such that they can communicate via RF to receive ID signals with all passenger LOCAMO trackers in the bus. By way of example, the inner SAs may be mmWave antenna-equipped terminals, medium range smartcard readers or Wi-Fi terminals placed at various positions within the bus.

VTFVs may be configured to provide a record of passenger boarding and alighting of a given vehicle in the order of stops made by the bus at its transfer nodes. Bus LOCAMO tracker 100 may be configured activate inner SA 124 to receive passenger IDs from all passenger LOCAMO trackers in the bus, by way of example passenger-operated smartphones or medium range smartcards, responsive to: (1) the bus approaching a transfer node where it is scheduled to make a stop; and (2) the bus departing from the transfer node. With reference to exemplary bus stop 32 shown in FIG. 2, bus LOCAMO tracker 100 may determine an imminent stop at bus stop 32 based on GPS and IMU data provided by GPS/IMU module 122, and/or reception of a transfer node ID signal from SA 204 comprised in X-node LOCAMO tracker 200, and may determine a departure from bus stop 32 responsive to a closure of passenger doors and initiation of translational movement past a threshold speed and/or attenuation of the transfer node ID signal from SA 204.

FIG. 7A shows a VTFV listing passenger IDs received by internal bus SA 124 at time points shortly before and after stops made by bus 24 at bus stop 32 and depot 34 as shown in FIG. 1. Each VTFV comprises the following features: a timestamp (vtfv₁); a bus stop ID (vtfv₂); whether or not the internal bus SA was activated before or after the bus door being opened for passenger boarding (vtfv₃); and individual passenger IDs (vtfv₄ and higher) read by internal bus SA 124 at the timestamp. According to VTFV₁, bus 24 as it approaches bus stop 32 has 7 passengers: Sarah D., Jonathan F., Saul A., Josh D., Mark S., Rachel H., and Eliana F. According to VTFV₂, bus 24 as it is leaving has five passengers: Sarah D., Jonathan F., Saul A., Josh D., Rebecca G., and John S. (which is the user of smartphone 44). According to VTFV₃, bus 24 as it is approaching depot 34 has the same five passengers as when the bust left bus stop 32 (which serves as confirmation of the passenger list). According to VTFV₃, bus 24 as it leaves depot 34 has three passengers: Sarah D., Jeremy R., and Brian G..

Bus LOCAMO module 100 of bus 24 or a remote LOCAMO module stored in hub 50 may compare the list of passengers in a pre-stop VTFV against the list of passengers in a post-stop VTFV to determine which passengers boarded the bus at the stop and which passengers alighted from the bus at the stop. As shown in a VBFV table shown in FIG. 7B, a LOCAMO module may create a set of vehicle boarding feature vectors (VBFVs) based on an analysis of VTFVs for listing passengers who boarded and alighted from bus stop 32 and depot 34, respectively. By way of example, comparing the respective passenger list comprised in VTFV₁ against VTFV₂ reveals that, at bus stop 32, Mark S., Rachel H., and Eliana F. alighted from bus 32, and Rebecca G. and John S. boarded the bus. Similarly comparing the respective passenger list comprised in VTFV₃ against VTFV₄ reveals that, at bus depot 34, Jonathan F., Saul A., Josh D., Rebecca G., and John S. alighted from the bus and Jeremy R. and Brian G. boarded the bus.

The present disclosure also includes transfer node feature vectors that describe passengers and vehicles traversing a given transfer node. By way of example, X-node LOCAMO tracker 200 located at bus station 32 may, through SA 204, collect microenvironment data that may include bus ID signals, such as from SA 126 mounted on bus 24, and passenger ID signals, such as from smartphone 44B carried by John. The collected microenvironment data, or event notices based on the data, may be processed locally to generate time-resolved transfer node feature vectors (TNFVs), and periodically transmitted to database 52 by network communications module 152 via communications channel 308. Alternatively, the LOCAMO data and event notices may be from X-node LOCAMO tracker 200 transmitted to database 52 to be used for processing by a remote LOCAMO module operating at hub 50 to generate a time-resolved set of TNFVs. TNFVs or aspects thereof may be stored in remote hub 50 as part of the transportation data repository to be used for analysis of subsequent LOCAMO data.

FIG. 8 shows a TNFV table showing an example set of TNFVs providing a history of vehicles and persons at bus station 32. Each TNFV includes the following features: a timestamped (as feature tnfv₁); up to three vehicle IDs (tnfv 2 through 4); and up to 6 person IDs (tnfv 5 through 10). By way of example, the LOCAMO module comprised in X-node LOCAMO tracker 200 instructs SA 204 to scan for ID signals from nearby vehicle LOCAMO tracker or a passenger LOCAMO trackers at a time interval of about 5, about 10, or about 15 seconds, and creates a new TNFV once every minute, with each TNFV including respective signal IDs from vehicle LOCAMO trackers and passenger LOCAMO trackers that was within proximity to provide a signal ID to SA 204 at least once, at least twice, or at least three times within the minute. As shown in FIG. 8, a bus having a vehicle ID of B5561 was detected to be in close proximity to bus stop 32 between 9:20 am and 9:21 am, a bus having a vehicle ID of B4253 was detected at 9:23 am, a TOD vehicle having a vehicle ID of TD4110 was detected between 9:24 am and 9:27 am, bus having a vehicle ID of B1669 was detected between 9:25 am and 9:29 am, and so forth. Also as shown in FIG. 8, John S. (the user of smartphone 44 as shown in FIG. 1) was detected between 9:20 am and 9:23 am, Judah C. was detected between 9:22 am and 9:23 am, and so forth.

It will be appreciated that a coordinated disappearance of a vehicle and a person may indicate that the person boarded the vehicle, and a coordinated appearance of a vehicle and a person may indicate that the person alighted from the vehicle. As such, the transit behavior of travelers at the transfer node may be inferred based on the sequence of TNFVs. By way of example, TNFV 3 through 5 may reflect John S. and Judah C. having boarded bus 23 having a vehicle ID of B4253, and also reflect Beth D. having alighted from the same bus. Similarly, TNFV₇ may indicate John A., Alice K., and Peter K. having boarded the bus having the vehicle ID of B9800. In addition, TNFV 4 through 16 may indicate that Beth D., after alighting from the bus having the vehicle ID of B4253 at 9:23 am, waited at the bus stop until 9:35 am, then boarded a TOD vehicle having the vehicle ID of TD4110.

Vehicle travel feature vectors and transfer node feature vectors may be advantageously useful as a parallel dataset to corroborate and improve accuracy of a passenger travel feature vector (which may be an MFV or a TrSF). In addition, vehicle travel feature vectors and travel node feature vectors may be useful in maintaining an accurate record of actual travel routes and travel times, including arrival times and departure times of vehicles at transfer nodes.

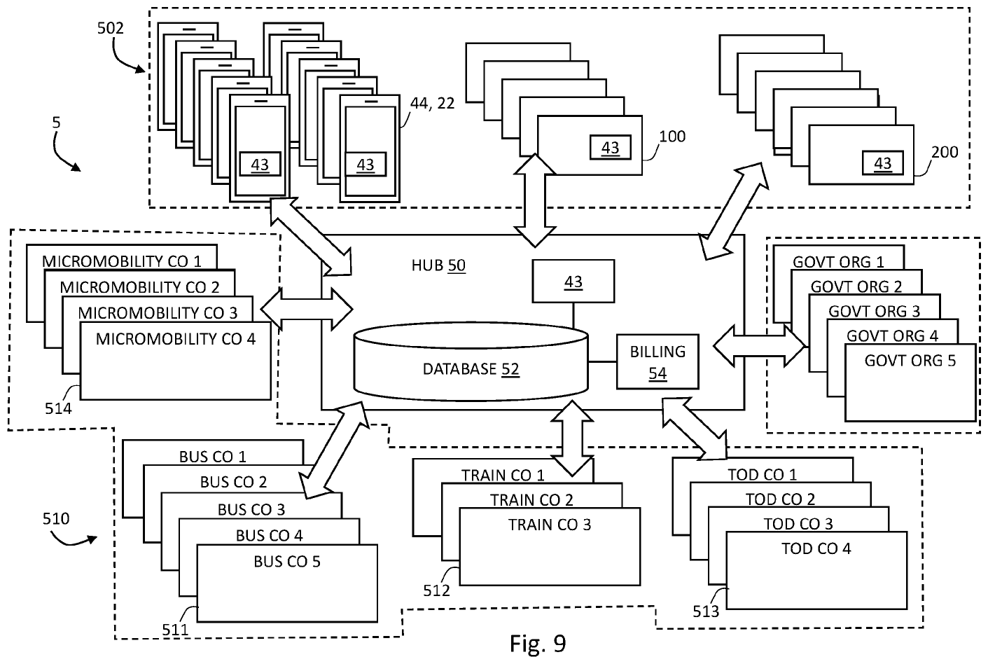

Reference is made to FIG. 9, which schematically shows UMOM 5 serving as an intermediary hub that integrates operation of a large-scale transportation system comprising thousands of smartphones 44 being carried by users traveling in vehicles operated by dozens transportation services in a variety of transportation modes. In accordance with an embodiment of the disclosure, the transportation system integration is achieved through centralized tracking of travel activity by users and optionally allocating payments by the users and various stakeholders within the transportation system responsive to the travel activity tracking.

As shown in the figure, UMOM 5 comprises a hub 50 that is configured to communicate with a plurality of smartphones 44, each smartphone 44 comprising an instance of a LOCAMO module 43 and serving as a LOCAMO tracker 42. Hub 50 and a given smartphone 44 exchange information in order to determine the travel itinerary of the user carrying smartphone 44, including the user's ridership of different transportation vehicles during the trip, and bill the user in accordance with the ridership. As described herein above, the information exchanged between a given smartphone 44 and hub 50 may include GEOTEMP data, TRAVCON data, movement feature vectors (MFVs) and portions thereof, and travel segment feature vectors (TrSFs) and portions thereof.

Smartphones 44 may serve as LOCAMO trackers 42 alone or as a part of the larger network 510 of LOCAMO trackers including vehicle-mounted LOCAMO trackers 100 and X-node LOCAMO trackers 200 that may provide additional user travel data from the perspective, respectively, of individual transportation vehicles ridden by travelers and transfer nodes such as bus stops and train stations traversed by the travelers.

Hub 50 may communicate, by way of example through an application programming interface (API), with a plurality of transportation services operating in the service area covered by UMOM 5. As shown in FIG. 9, hub 50 may communicate with many transportation services 510, including bus companies 511, train companies 512, TOD companies 512 including car-sharing platforms, and micro-mobility companies 514. Each transportation service may interface with hub 50 in order to, by way of example, provide UMOM 5 with routes and route schedules for the vehicles operated by the respective transportation services, as well as fee and discount schedules usable by billing module 54 to determine user fares for billing purposes, as well as contractual information controlling disbursement of payments, discounts, and fees to users and other parties. Whereas FIG. 9 shows vehicle-mounted LOCAMO trackers 100 and X-node LOCAMO trackers 200 communicating directly with hub 50, it will appreciated that individual transportation services, or a group of transportation services may deploy and operate its own vehicle-mounted LOCAMO trackers 100 and X-node LOCAMO trackers to collect LOCAMO data to generate its own vehicle travel feature vectors (VTFVs) and travel node feature vectors (TNFV), which are then provided to hub 50.

Hub 50 may communicate, by way of example through an API with a plurality of government organizations 515 having jurisdiction in the service area covered by UMOM 5. The plurality of government organizations may include, by way of example, national, state, and municipal governments, regional transportation boards, police departments, and the like. The government organizations may provide discount and stimulus schedules usable by billing module 54 to determine fares and billing activity, as well as contractual information controlling disbursement of payments, discounts, and fees to users and other parties.

There is therefore provided in accordance with an embodiment of the disclosure a first system for tracking a user's use of available modes of transportation during a trip between an origin and a destination, the first system comprising: a global navigation satellite system (GNSS) receiver configured to provide location data tracking a user during the trip; an inertial measurement unit (IMU) configure to provide inertial data based on the movement of the user during the trip; and one or more processors that operates in accordance with a set of instructions stored in a memory to: generate a geotemporal record of a travel route of the trip based on the location data provided by the GNSS receiver and the inertial data provided by the IMU; and determine, based on the geotemporal record, at least one vehicular trip segment along the travel route in which the user rode on a vehicle.

Optionally, each segment of the at least one vehicular trip segment is characterized with a start time, a start location, an end time and an end location, a transportation mode of the vehicle, and a transportation service operating the vehicle.

Optionally, the transportation mode is selected from the group consisting of a public transport system (PTS) mode, a micro-mobility mode of transportation (MIMOT), or a transportation on demand (TOD) mode.

In an embodiment of the disclosure, the determining of the at least one vehicular trip segment is responsive to detecting a discontinuity in the geotemporal record of the trip. Optionally, the discontinuity in the geotemporal record comprises a discontinuity in velocity. Optionally, the generating of the geotemporal record of the travel route comprises determining a motion type of the user based on the inertial data, and the discontinuity in the geotemporal record comprises a discontinuity in the motion type of the user. Optionally, the motion type is selected from the group consisting of standing, walking, and riding in a vehicle. Optionally, the first system comprises an RF receiver, wherein: the geotemporal record of the travel route is generated further based on one or more radio-frequency ID (RFID) signals that comprises an identification and indicates proximity of a source of the one or more RFID signal to the RF receiver; and the discontinuity in the geotemporal record comprises a discontinuity in a strength of the one or more RFID signals received by the RF receiver. Optionally, the identification comprised in the RFID signal is associated with a particular transfer node, a particular transportation service operating the vehicle, or a unique identification of the vehicle. Optionally, the RFID signal is a signal received from an RFID tag, a contactless smartcard, a two-way NFC device, a Wi-Fi terminal, a millimeter wavelength (mmWave) antenna-equipped terminal, or a Bluetooth-enabled device. Optionally, the transportation mode or the transportation service of the vehicle is identified responsive to the one or more RFID signals. Optionally, the system comprising an optical signal receiver, wherein: the geotemporal record of the travel route is generated further based on one or more optical features based on one or more images captured by the optical signal receiver, the one or more optical feature comprising a location, an identification of the vehicle, the transportation mode of the vehicle, or the transportation service operating the vehicle; and the discontinuity in the geotemporal record comprises a discontinuity in the one or more optical features. Optionally, the one or more images comprises an image of a bar code or a QR code. Optionally, the one or more images are captured by a camera, and the optical features are derived from a visual object recognition module that is configured to identify from the one or more images a location, an identification of the vehicle, the transportation mode of the vehicle, or the transportation service of the vehicle. Optionally, the optical signal receiver is comprised in a mobile communication device carried by the user. Optionally, an identification of the vehicle, the transportation mode of the vehicle, or the transportation service of the vehicle is identified responsive to the one or more optical features.

In an embodiment of the disclosure, the transportation mode or the transportation service operating the vehicle is identified by cross-referencing the start time, start location, end time, or end location of the at least one vehicular trip segment with a transportation data repository. Optionally, the transportation data repository comprises one or more selections from the group consisting of: a database of known transfer node locations designated for vehicle boarding and alighting; a schedule of vehicle operation; a history of vehicle operation; a history of past travel itineraries of the user; and geotemporal records of other users.

In an embodiment of the disclosure, the GNSS receiver and the IMU are comprised in a mobile communication device carried by the user. Optionally, the GNSS receiver, the IMU, and the RF receiver is comprised in a mobile communication device carried by the user.

In an embodiment of the disclosure, the first system further comprises a remote hub that is located remotely from the user, and wherein the remote hub comprises at least one processor of the one or more processors.

In an embodiment of the disclosure, the geotemporal record comprises one or more feature vectors.

In an embodiment of the disclosure, the first system further comprises a billing module that, responsive to the one or more processors operating according to the set of instructions, is configured to determine a fee responsive to one or more features of the at least one vehicular trip segment. Optionally, the fee is determined after completion of the trip. Optionally, the fee is determined responsive to travel conditions at the time of the at least one segment. Optionally, the travel conditions comprise a real-time degree of congestion or an expected degree of congestion based on time of day in the route of the at least one segment and a higher degree of congestion results in the fee being increased. Optionally, the travel conditions comprise an abundance of other riders in the vehicle associated with the at least one segment, and a higher abundance of other riders results in the fee being increased. Optionally, the at least one segment comprises a plurality of segments, and the fee is adjusted responsive to a combination of different pluralities of segments.

There is also provided in accordance with an embodiment of the disclosure a second system, for tracking a user's use of available modes of transportation during a trip between an origin and a destination, the second system comprising: a remote hub comprising a transportation data repository comprising one or more selections from the group consisting of: a database of known transfer node locations designated for vehicle boarding and alighting; a schedule of vehicle operation; a history of vehicle operation; a history of past travel itineraries of the user; and geotemporal records of other users; and one or more processors that operates in accordance with a set of instructions stored in a memory to determine, based on a user record of the trip and the transportation data repository, at least one vehicular trip segment of the trip in which the user rode on a vehicle. Optionally, each segment of the at least one vehicular trip segment is characterized with a start time, a start location, an end time and an end location, a transportation mode of the vehicle, and a transportation service operating the vehicle. Optionally, the transportation mode is selected from the group consisting of a public transport system (PTS) mode, a micro-mobility mode of transportation (MIMOT), or a transportation on demand (TOD) mode. Optionally, the user record comprises a geotemporal record of the user's location and movement during the trip, wherein the geotemporal record is based on location data received from a global navigation satellite system (GNSS) receiver and inertial data received from an inertial measurement unit (IMU) comprised in a mobile communication device carried by the user. Optionally, determining the at least one vehicular trip segment is responsive to detecting a discontinuity in the geotemporal record of the trip. Optionally, the discontinuity in the geotemporal record comprises a discontinuity in velocity. Optionally, the geotemporal record of the trip comprises a motion type of the user based on the inertial data, and the discontinuity in the geotemporal record comprises a discontinuity in the motion type of the user. Optionally, the motion type is selected from the group consisting of standing, walking, and riding in a vehicle.

In an embodiment of the disclosure, the user record of the trip comprises a record of on one or more radio-frequency ID (RFID) signals that comprises an identification and indicates proximity of a source of the RFID signal that was received by an RF receiver during the trip. Optionally, the identification comprised in the RFID signal is associated with the user, a particular transfer node, a particular vehicle, or a particular transportation service operating the vehicle. Optionally, the RFID signal is a signal received from an RFID tag, a contactless smartcard, a two-way NFC device, a Wi-Fi terminal, a millimeter wavelength (“mmWave”) antenna-equipped terminal, or a Bluetooth-enabled device. Optionally, the RFID signal is received by an RF receiver comprised in the mobile communication device carried by the user. Optionally, the RFID signal is received by an RF receiver mounted in a vehicle ridden by the user during the trip. Optionally, the RFID signal is received by an RF receiver located at a transfer node traversed by the user during the trip. Optionally, the determining of the at least one vehicular trip segment is responsive to detecting a discontinuity in a strength of the one or more RFID signals received by the RF receiver. Optionally, the transportation mode and the transportation service of the vehicle is identified responsive to the one or more RFID signals.

In an embodiment of the disclosure, the user record of the trip comprises on one or more optical features based on one or more images captured by an optical signal receiver, wherein the one or more optical features comprise an identification of the user, the transportation mode, or a transportation service operating the vehicle. Optionally, the one or more images comprises an image of a bar code or a QR code. Optionally, the one or more images are captured by a camera, and the optical features are derived from a visual object recognition module that is configured to identify from the one or more images a location, a transportation mode, a transportation service, or a user based on visual cues. Optionally, the optical signal receiver is comprised in a mobile communication device carried by the user. Optionally, the optical signal receiver is mounted in a vehicle ridden by the user during the trip. Optionally, the optical signal receiver is located at a transfer node traversed by the user during the trip. Optionally, the determining of the at least one vehicular trip segment is responsive to detecting a discontinuity in one or more optical features. Optionally, the transportation mode and the transportation service of the vehicle is identified responsive to the one or more optical features.

In an embodiment of the disclosure, the user record comprises one or more feature vectors.

In an embodiment of the disclosure, the second system comprises a billing module that is configured to determine a fee responsive to one or more features of the at least one vehicular trip segment. Optionally, the fee is determined after completion of the trip. Optionally, the fee is determined responsive to travel conditions at the time of the at least one segment. Optionally, the travel conditions comprise a real-time degree of congestion or an expected degree of congestion based on time of day in the route of the at least one segment and a higher degree of congestion results in the fee being increased. Optionally, the travel conditions comprise an abundance of other riders in the vehicle associated with the at least one segment, and a higher abundance of other riders results in the fee being increased. Optionally, the at least on vehicular trip segment comprises a plurality of segments, and the fee is adjusted responsive to a combination of different pluralities of segments.

There is also provided in accordance with an embodiment of the disclosure a third system, for determining a fee for a user's use of available modes of transportation during a trip between an origin and a destination, the system comprising: a remote hub comprising, storing, or configured to have access to: a transportation data repository; a plurality of fee schedules, each fee schedule of the plurality of fee schedules defining fees for usage of vehicles operated by a given transportation service; and contractual agreement data based on contractual agreements between a plurality of transportation system participants; and one or more processors that, when operating according to a set of instructions stored in a memory is configured to: receive a trip segment record of one or more vehicular trip segments along a travel route, each segment of the one or more vehicular trip segments being characterized with a start time, a start location, an end time, an end location, a transportation mode of a vehicle boarded by the user, and a transportation service operating the vehicle; and determine a fee to be paid by the user for the trip responsive to the trip segment record, the transportation data repository, the plurality of fee schedules, and the contractual agreement data.

In an embodiment of the disclosure, the transportation data repository comprises one or more selections from the group consisting of: a database of known transfer node locations designated for vehicle boarding and alighting; a schedule of vehicle operation; a history of vehicle operation; a history of past travel itineraries of the user; and geotemporal records of other users

In an embodiment of the disclosure, the fee is determined after completion of the trip.

In an embodiment of the disclosure, the fee is determined responsive to travel conditions along a route of the one or more vehicular trip segments. Optionally, the travel conditions comprise a real-time degree of congestion or an expected degree of congestion based on time of day along the route and a higher degree of congestion results in the fee being increased. Optionally, the travel conditions comprise an abundance of other riders in the vehicle associated with the at least one segment, and a higher abundance of other riders results in the fee being increased.

In an embodiment of the disclosure, the one or more vehicular trip segments comprise a plurality of vehicular trip segments, and the fee is adjusted responsive to a combination of the pluralities of segments, based on the plurality of fee schedules and the contractual agreement data.

In an embodiment of the disclosure, the one or more processors is configured to determine a payment to be received or a fee to be paid by one or more of the plurality of transportation system participants responsive to the trip segment record, the plurality of fee schedules and the contractual agreement data.

In an embodiment of the disclosure, the plurality of transportation system participants comprises: a plurality of transportation services operation transportation vehicles, a plurality of government bodies, and an operator of the hub.

There is also provided in accordance with an embodiment of the disclosure a first method, for tracking vehicles boarded by a passenger, the method comprising: determining a vehicle identification of a vehicle boarded by a passenger; determining a passenger identification of the passenger boarding the vehicle; transmitting to a remote hub a boarding notice indicating boarding of the passenger onto the vehicle, the boarding notice comprising the vehicle identification and the passenger identification.

In an embodiment of the disclosure, the determining of the vehicle identification comprises a passenger communication device carried by the passenger receiving the vehicle identification from a vehicle wireless communication device mounted on the vehicle, responsive to the vehicle communication device and the passenger wireless communication device becoming sufficiently close for direct wireless communication; the passenger identification is stored in a memory operatively connected to the passenger communication device; and the passenger communication device transmits the boarding notice to the remote hub.

In an embodiment of the disclosure, the boarding notice comprises one or more of: a time of boarding and a location of boarding.

In an embodiment of the disclosure, the method further comprises: detecting disembarkation of the passenger from the vehicle; and transmitting to the remote hub a disembarkation notice comprising the vehicle identification and the passenger identification.

There is also provided herewith in accordance with an embodiment of the disclosure a second method, for tracking transit vehicles arriving at a transit stop, the method comprising: determining a transit stop identification of a transit stop at which a vehicle arrives to pick up and/or drop off passengers; determining a vehicle identification of the vehicle; and transmitting to a remote hub an arrival notice indicating arrival of the vehicle at the transit stop, the arrival notice comprising the transit stop identification, an arrival timestamp, and a passenger identification.

In an embodiment of the disclosure, the determining of the vehicle identification comprises: a transit stop wireless communication device mounted at the transit stop receiving the passenger identification from a vehicle wireless communication device mounted on the vehicle, responsive to the vehicle communication device and the transit stop wireless communication device becoming sufficiently close for direct wireless communication; the transit stop identification is stored in a memory operatively connected to the transit stop communication device; and the transit stop communication device transmits the arrival notice to the remote hub. Optionally, the determining of the transit stop identification comprises: a vehicle communication device mounted on the vehicle receiving the transit stop identification from a transit stop wireless communication device mounted at the transit stop, responsive to the vehicle communication device and the transit stop wireless communication device becoming sufficiently close for direct wireless communication; the vehicle identification is stored in a memory operatively connected to the vehicle communication device; and the vehicle communication device transmits the boarding notice to the remote hub.

In an embodiment of the disclosure, the second method further comprises: detecting departure of the vehicle from the transit stop; and transmitting to the remote hub a departure notice indicating the vehicle having departed from the transit stop, the departure notice comprising the vehicle identification, the transit stop identification, and a departure timestamp.

Descriptions of embodiments are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the invention is limited only by the claims.

1-58. (canceled)

59. A system for determining a fee for a user's use of available modes of transportation during a trip between an origin and a destination, the system comprising:
a remote hub comprising, storing, or configured to have access to:
a transportation data repository;
a plurality of fee schedules, each fee schedule of the plurality of fee schedules defining fees for usage of vehicles operated by a given transportation service; and
contractual agreement data based on contractual agreements between a plurality of transportation system participants; and
one or more processors that, when operating according to a set of instructions stored in a memory is configured to:
receive a trip segment record of one or more vehicular trip segments along a travel route, each segment of the one or more vehicular trip segments being characterized by a trip segment feature vector having features determined by a neural network that includes a start time, a start location, an end time, an end location, a transportation mode of a vehicle boarded by the user, and a transportation service operating the vehicle; and
determine a fee to be paid by the user for the trip responsive to the trip segment record, the transportation data repository, the plurality of fee schedules, and the contractual agreement data.

60. The system according to claim 59, wherein the transportation data repository comprises one or more selections from the group consisting of:
a database of known transfer node locations designated for vehicle boarding and alighting;
a schedule of vehicle operation;
a history of vehicle operation;
a history of past travel itineraries of the user; and
geotemporal records of other users

61. The system according to claim 59, wherein the fee is determined after completion of the trip.

62. The system according to claim 59, wherein the features of the trip segment feature vector determined by the neural network include features defining travel conditions along a route of one or more of the vehicular trip segments and the fee is determined responsive to the travel conditions.

63. The system according to claim 62, wherein the travel conditions comprise a real-time degree of congestion or an expected degree of congestion based on time of day along the route and a higher degree of congestion results in the fee being increased.

64. The system according to claim 62, wherein the travel conditions comprise an abundance of other riders in the vehicle associated with the at least one segment, and a higher abundance of other riders results in the fee being increased.

65. The system according to claim 59, wherein the one or more vehicular trip segments comprise a plurality of vehicular trip segments, and the fee is adjusted responsive to a combination of the pluralities of segments, based on the plurality of fee schedules and the contractual agreement data.

66. The system according to claim 59, wherein the one or more processors is configured to determine a payment to be received or a fee to be paid by one or more of the plurality of transportation system participants responsive to the trip segment record, the plurality of fee schedules and the contractual agreement data.

67. The system according to claim 59, wherein the plurality of transportation system participants comprises: a plurality of transportation services operation transportation vehicles, a plurality of government bodies, and an operator of the hub.

68-75. (canceled)
